(19) United States
(12) Patent Application Publication
(10) Pub. No.: US 2014/0289159 A1
(43) Pub. Date: Sep. 25, 2014

(54) OPEN SOURCE SOFTWARE PRODUCTS ASSESSMENT

(71) Applicants: Jayant Sudhakarrao DANI, Mumbai (IN); Rajashree DAS, Mumbai (IN); TATA CONSULTANCY SERVICES LIMITED, MUMBAI (IN)

(72) Inventors: Rajashree DAS, Mumbai (IN); Jayant Sudhakarrao DANI, Mumbai (IN)

(73) Assignee: TATA CONSULTANCY SERVICES LIMITED, MUMBAI (IN)

(21) Appl. No.: 13/899,740

(22) Filed: May 22, 2013

(30) Foreign Application Priority Data
Mar. 22, 2013 (IN) 1021/MUM/2013

(51) Int. Cl. G06Q 30/02

(52) U.S. Cl. CPC G06Q 30/0282
USPC 705/347

(57) ABSTRACT

An assessment system for assessment of Open Source Software (OSS) products including a computation module configured to receive a rating, for product criterions of each OSS product from an assessor, based on product parameters of each of the OSS products. The product criterions are associated with one or more product categories. The computation module is further configured to compute a product weighted score for each product criterion based at least on the rating and then generates a product scorecard for each OSS product. Upon generation of the product scorecards, an assessing module is configured to identify an optimum OSS product amongst the OSS products based on the assessment of the product scorecard and a benchmark scorecard of an OSS product.

### TECHNICAL FIELD

The present subject matter relates, in general, to Open Source Software (OSS) products and, in particular, to a system and a computer-implemented method for assessment of the OSS products.

### BACKGROUND

The acceptance and adoption of Open Source Software (OSS) products is widespread and is expanding rapidly across organizations for different uses, such as office automation, web designing, content management, and communication. OSS is a software program that is made publicly available and freely downloadable, typically from the Internet. OSS offers freedom to the users to run the program, to study and modify the program, and to redistribute copies of the original and the modified program without having to pay royalties to the developers of the OSS.

While most of the organizations nowadays are using OSS products in some way or the other, many organizations using OSS products are dealing with the major problem of selecting an appropriate product corresponding to their needs because there are a variety of OSS products that range widely in terms of quality, stability and performance.

### SUMMARY

This summary is provided to introduce concepts related to assessment of open source software (OSS) products, which are further described below in the detailed description. This summary is neither intended to identify essential features of the claimed subject matter nor is it intended for use in determining or limiting the scope of the claimed subject matter.

An assessment system for assessment of a plurality of OSS products includes a computation module configured to receive a rating for each of a plurality of product criterions of each OSS product, from an assessor, based on product parameters of each of the OSS products. The plurality of product criterions is associated with one or more product categories. The computation module is further configured to compute a product weighted score for each product criterion based at least on the rating and then generates a product scorecard for each OSS product. Upon generation of the product scorecards, an assessing module is configured to identify an optimum OSS product amongst the plurality of OSS products based on the assessment of the product scorecard and a benchmark scorecard of an OSS product.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a network environment implementation of an assessment system, in accordance with an embodiment of the present subject matter.

FIGS. 2a, 2b, and 2c illustrate exemplary bar chart representations and a radar chart representation depicting comparison of scores attained by product 1, product 2, and product 1 with a benchmark score.

FIG. 3 illustrates a computer-implemented method for assessment of a plurality of Open Source Software (OSS) products to identify an optimum OSS product, in accordance with the embodiment of the present subject matter.

### DETAILED DESCRIPTION

Conventionally, various assessment techniques and models are available that help organizations to choose an appropriate OSS product for their organizations. One of such assessment techniques involves selecting an OSS product amongst multiple OSS products based on customers' reviews about the OSS products as available on Internet or other sources. However, in reality, the reviews available on Internet are quite often inaccurate and unreliable. For example, taking into account the cost parameter of the OSS product, certain users may provide their reviews in terms of the initial purchase price and do not consider the cost of software during its entire lifecycle. Also, the users do not take into account the long-term support and maintenance needs, in addition to other less tangible issues such as usability of the product and productivity gains while giving their reviews about the OSS product. Therefore, selection of an OSS product based on reviews provided by the users might not be accurate and reliable.

Other assessment techniques and models select an OSS product solely based on maturity of the product, i.e., for how long that product is in the market. Such techniques do not consider other relevant parameters, such as product architecture, product support, product strategy, usability, security, performance, and maintainability of the product. Thus, such a selection process relying solely on the maturity of the product may not be accurate.

In accordance with the present subject matter, a system(s) and a computer-implemented method(s) for assessment of Open Source Software (OSS) products are described. According to the system and the method, OSS products are assessed based on a plurality of pre-defined product categories and product criterions to identify an optimum OSS product. An optimum OSS product referred herein may be understood as an OSS product that is well-designed, license friendly, and can be efficiently used in coding.

Initially, a plurality of product categories associated with a plurality of OSS products is defined by an administrator, such as a technology expert. The product categories may include, but not limited to, an ‘About Product’ category, a ‘Product Strategy’ category, a ‘Product Offerings’ category, a ‘Product Architecture’ category, a ‘Product Support’ category, and a ‘Commercials’ category. For each of the product categories, a plurality of product criterions is defined by the administrator. As an example, for the product category ‘About Product’, the product criterions such as a ‘Launch Year’ criterion, a ‘Latest Version/Release Date’ criterion, a ‘History’ criterion, a ‘Product Technology’ criterion, a ‘Product Components’ criterion, a ‘Certifications’ criterion, a ‘Product Deployment(s)’ criterion, and a ‘Product Competition’ criterion can be defined by the administrator.

Once the product categories and product criterions are defined, a score (hereinafter referred to as a criterion score) is allotted to each of the product criterions of an OSS product based on a various product parameters. For example, a criterion score 3 may be allocated to the product criterion ‘Launch Year’, if the product parameters indicates that the OSS product is in the market for more than 5 years. Once the criterion scores are allotted, a weight is assigned to each of the product criterions upon receiving input from an assessor, such as a technologist. In an example, if the product criterion ‘Product Technology’ is most relevant with respect to product category ‘About Product’, then the assessor may provide a weight of 5, which is then assigned to the ‘Product Technology’.

Subsequent to assignment of the weight, an ideal scorecard and a benchmark scorecard are generated for the OSS product. The ideal scorecard is generated based on a cumulative sum of ideal score of all the product categories, and the benchmark scorecard is generated based on a cumulative sum of benchmark score of all the product categories. The ideal score may be understood as a best possible score for a product in a product category, and the benchmark score may be understood as a reference score for a product in a product category against which the product can be assessed for selection.

For generation of the ideal scorecard and the benchmark scorecard, criterion scores are selected from amongst the allotted criterion scores. The ideal scorecard is generated based on selecting a criterion score which is the best possible score from amongst the criterion scores and the benchmark scorecard is generated based on selecting a criterion score which is the reference score for a product in a product category against which the product can be assessed for selection. In an example, a second best possible score may be selected as the reference score for a product.

Further, a weighted score is calculated for each product criterion based on the selected criterion score and the weight assigned to each of the product criterions. For example, for the product criterion ‘Launch Year’, the weighted score is calculated based on the selected criterion score and weight assigned to it. The weighted score may be calculated by multiplying the selected criterion score and the weight. In the said example, weighted score of 6 (2×3) is calculated. Further, the weighted scores of each product criterion of the one or more product categories are added together to get an ideal score and a benchmark score for each product category. Thus, if the weights are modified by the assessor or the end user, the benchmark scores and the ideal scores may get modified.

Thereafter, a rating is received from the assessor for each of the product criterions of the plurality of OSS products. In one implementation, the assessor may provide the rating based on the product parameters associated with the product criterions. In an example, ratings for three OSS products, namely product 1, product 2, and product 3 may be received from the assessor. Taking an example of product 1 which is in market for more than 5 years, for the product criterion ‘Launch Year’, the rating of 3 may be received based on the product parameter, that is, product is in market for more than 5 years. In another example, if the product 2 is in market for less than 2 years, then rating of 1 is received for the product criterion ‘Launch Year’.

Based on the received rating, a product scorecard is generated for each of the plurality of OSS products. The product scorecard for an OSS product may be indicative of a total product score, i.e., cumulative sum of product scores of all the product categories. The product score for each category is calculated based on computing a product weighted score for each of the product criterions of the one or more product category. For computation of the product weighted score for a product criterion, the received rating is multiplied with the weight of the product criterion.

Once the ideal scorecard, the benchmark scorecard, and the product scorecards are generated, the product score of each product category of each of the OSS products is compared with the benchmark score of each category. If any of the OSS product has product scores that is equal to or surpasses the benchmark score of all product categories individually, then that OSS product is considered as an optimum OSS product. In a scenario where two OSS products have product scores greater than the benchmark scores, then that OSS product is identified as an optimum OSS product for which the total product score is equal to or close to the total ideal score. In another scenario where two OSS products have equal product scores and the product scores are greater than the benchmark scores, then that OSS product is identified as an optimum OSS product which has lower commercial cost. Therefore, based on such an exhaustive collection of product categories and product criterions which are easily embeddable codes, and scoring mechanism, an optimum OSS product is reliably and accurately identified for adoption based on requirement of the user. Further, the identified OSS product is stable.

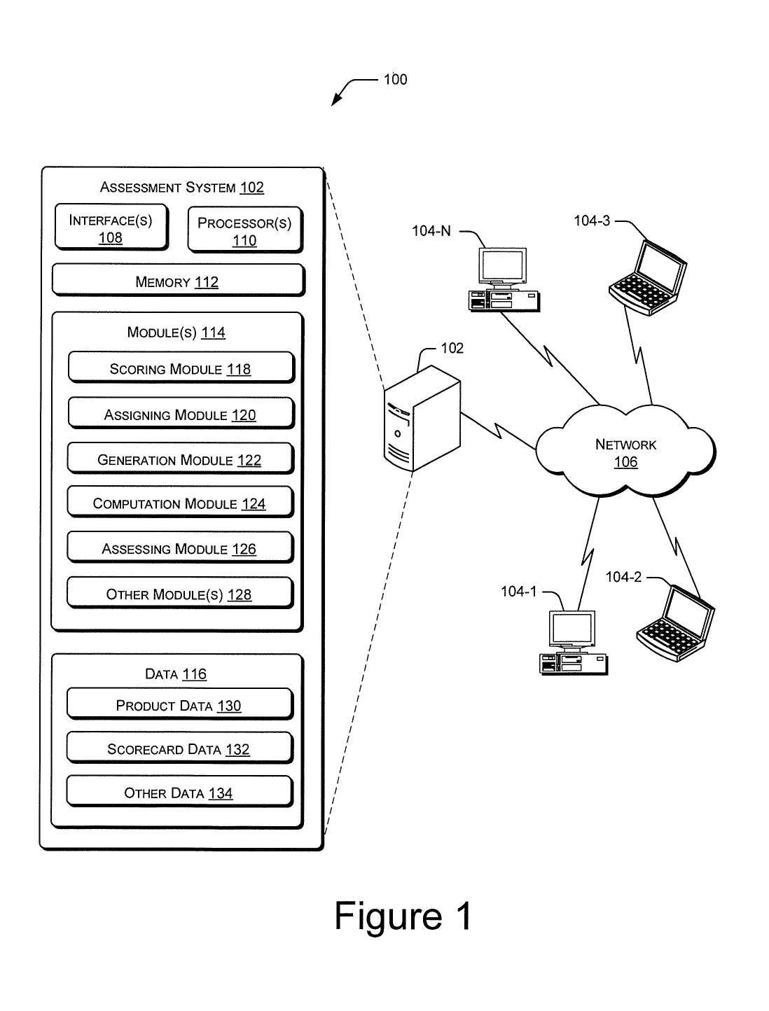

FIG. 1 illustrates a network environment 100 implementing an assessment system 102, in accordance with an embodiment of the present subject matter. In said embodiment, the network environment 100 includes the assessment system 102 configured to assessing a plurality of Open Source Software (OSS) products to identify an optimum Open OSS product. An optimum OSS product may be understood as an OSS product that is well-designed, i.e., can be efficiently used in coding, is license friendly integrated management, and has abundant support from organizations.

In one implementation, the network environment 100 can be a public network environment, including thousands of personal computers, laptops, various servers, such as blade servers, and other computing devices. In another implementation, the network environment 100 can be a private network environment with a limited number of computing devices, such as personal computers, servers, laptops, and/or communication devices, such as mobile phones and smart phones.

The assessment system 102 may be implemented in a variety of computing systems, such as a laptop computer, a desktop computer, a notebook, a workstation, a mainframe computer, a server, a network server, and the like. In one implementation, the assessment system 102 may be included within an existing information technology infrastructure or a database management structure. Further, it will be understood that the assessment system 102 may be connected to a plurality of user devices 104-1, 104-2, 104-3, . . . , 104-N, collectively referred to as user devices 104 and individually referred to as a user device 104. The user device 104 may include, but is not limited to, a desktop computer, a portable computer, a mobile phone, a handheld device, and a workstation. The user devices 104 may be used by users, such as decision holders, for example, Architects, technologists and the like.

As shown in FIG. 1, the user devices 104 are communicatively coupled to the assessment system 102 over a network 106 through one or more communication links for facilitating one or more end users to access and operate the assessment system 102. In one implementation, the network 106 may be a wireless network, a wired network, or a combination thereof. The network 106 may also be an individual network or a collection of many such individual networks, interconnected with each other and functioning as a single large network, e.g., the Internet or an intranet. The network 106 may be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 106 may include a variety of network devices, including routers, bridges, servers, computing devices, storage devices, and the like.

The assessment system 102 further includes interface(s) 108. Further, the interface(s) 108 may include a variety of software and hardware interfaces, for example, interfaces for peripheral device(s), such as a product board, a mouse, an external memory, and a printer. Additionally, the interface(s) 108 may enable the assessment system 102 to communicate with other devices, such as web servers and external repositories. The interface(s) 108 may also facilitate multiple communications within a wide variety of networks and protocol types, including wired networks, for example, LAN, cable, etc., and wireless networks, such as WLAN, cellular, or satellite. For the purpose, the interface(s) 108 may include one or more ports.

In an implementation, the assessment system 102 includes processor(s) 110 coupled to a memory 112. The processor(s) 110 may be implemented as one or more microprocessors, microcomputers, microcontrollers, digital signal processors, central processing units, state machines, logic circuitries, and/or any devices that manipulate signals based on operational instructions. Among other capabilities, the processor(s) 110 may be configured to fetch and execute computer-readable instructions stored in the memory 112.

The memory 112 may include any computer-readable medium known in the art including, for example, volatile memory, such as static random access memory (SRAM), and dynamic random access memory (DRAM), and/or non-volatile memory, such as read only memory (ROM), erasable programmable ROM, flash memories, hard disks, optical disks, and magnetic tapes.

Further, the assessment system 102 includes module(s) 114 and data 116. The module(s) 114 include, for example, a scoring module 118, an assigning module 120, a generation module 122, a computation module 124, an assessing module 126, and other module(s) 128. The other module(s) 128 may include programs or coded instructions that supplement applications or functions performed by the assessment system 102.

The data 116 may include product data 130, scorecard data 132, and other data 134. The product data 130 includes data associated with a plurality of Open Source Software (OSS) products, interchangeably referred to as products. The data includes product categories associated with each OSS product. The one or more product categories referred herein may include, but not limited to, an ‘About Product’ category, a ‘Product Strategy’ category, a ‘Product Offerings’ category, a ‘Product Architecture’ category, a ‘Product Support’ category, and a ‘Commercials’ category.

Further, a plurality of product criterions is associated with the product categories. For example, the product category ‘About Product’, includes product criterions based on the OSS product related details, such as a ‘Launch Year’ criterion, a ‘Latest Version/Release Date’ criterion, a ‘History’ criterion, a ‘Product Technology’ criterion, a ‘Product Components’ criterion, a ‘Certifications’ criterion, a ‘Product Deployment(s)’ criterion, and a ‘Product Competition’ criterion. In another example, the product category ‘Product Strategy’ may have product criterions based on the strategy of the product, such as a ‘Product Roadmap’ criterion, a ‘Technology Partner’ criterion, a ‘Solution Partner’ criterion, a ‘System Integrator Partner’ criterion, and a ‘Analyst Endorsement’ criterion associated therewith.

The scorecard data 132 includes a benchmark scorecard, an ideal scorecard, and product scorecards of each of the OSS products. The other data 134, amongst other things, may serve as a repository for storing data that is processed, received, or generated as a result of the execution of one or more modules in the module(s) 114. Although the data 116 is shown internal to the assessment system 102, it may be understood that the data 116 can reside in an external repository (not shown in the figure), which may be coupled to the assessment system 102. The assessment system 102 may communicate with the external repository through the interface(s) 108 to obtain information from the data 116.

In an implementation, the scoring module 118 of the assessment system 102 may be configured to retrieve product data 130 stored in the data 116. As indicated previously, the product data 130 may include data associated with a plurality of OSS products. The data may include one or more product categories associated with each OSS product and each of the one or more product categories includes a plurality of product criterions. The one or more product categories referred herein may include, but not limited to, the ‘About Product’ category, the ‘Product Strategy’ category, the ‘Product Offerings’ category, the ‘Product Architecture’ category, the ‘Product Support’ category, and the ‘Commercials’ category.

In the said implementation, the scoring module 118 may be configured to retrieve data associated with an OSS product. The data associated with the OSS product may be the one or more product categories. Each of the product categories may have a plurality of product criterions associated therewith. In an example, the data may include six product categories. The six product categories may include the ‘About Product’ category, the ‘Product Strategy’ category, the ‘Product Offerings’ category, the ‘Product Architecture’ category, the ‘Product Support’ category, and the ‘Commercials category.

The product category ‘About Product’ may include the product criterions based on the details related to the product. The product criterions may include a ‘Launch Year’ criterion, a ‘Latest Version/Release Date’ criterion, a ‘History’ criterion, a ‘Product Technology’ criterion, a ‘Product Components’ criterion, a ‘Certifications’ criterion, a ‘Product Deployment(s)’ criterion, and a ‘Product Competition’ criterion.

The product category ‘Product Strategy’ may include the product criterions based on the strategy of the product. The product criterions may include a ‘Product Roadmap’ criterion, a ‘Technology Partner’ criterion, a ‘Solution Partner’ criterion, a ‘System Integrator Partner’ criterion, and an ‘Analyst Endorsement’ criterion. Further, the product category ‘Product Offerings’ may include product criterions based on the features of the product. The product criterions may be a ‘Core Features’ criterion and an ‘Advanced Features’ criterion of the OSS product.

The product category ‘Product Architecture’ may include product criterions, such as an ‘Architecture Principles’ criterion, an ‘Industry Standards Compliance for Interoperability’ criterion, a ‘Platform Support/Portability’ criterion, a ‘Security’ criterion, a ‘Usability’ criterion, a ‘Performance’ criterion, a ‘Scalability’ criterion, an ‘Extensibility’ criterion, an ‘Integration’ criterion, and a ‘Maintainability’ criterion.

The product category ‘Product Support’ may include product criterions, such as a ‘Product Documentation’ criterion, an ‘Ease of Development’ criterion, a ‘Community Strength’ criterion, a ‘Training’ criterion, and a ‘Professional Services’ criterion. Furthermore, the product category ‘Commercials’ may include product criterions, such as a ‘Licensing’ criterion, a ‘Cost’ criterion, and a ‘Warranty/Indemnity Coverage’ criterion.

### Allocation of Criterion Scores to Each of the Product Criterions

In an implementation, the scoring module 118 may further be configured to allot a plurality of scores (hereinafter referred to as criterion scores) to each of the product criterions based on a plurality of pre-defined product parameters.

In an example, the scoring module 118 may be configured to allot criterion scores to the product criterion ‘Launch Year’ based a product parameter, such as the year when the OSS Product was first released in the market. For example, if the product is in market for a longer period, then the product would be more mature or stable. In the said example, if the OSS product is in the market for more than 5 years, then the scoring module 118 is configured to allot a criterion score of 3 to the product criterion ‘Launch Year’. If the OSS product is in market for more than 2 years but less than 5 years, then the scoring module 118 is configured to allot a criterion score of 2 and if the OSS product is in market for less than 2 years, then a criterion score of 1 is allotted.

Further, the scoring module 118 may be configured to allot criterion scores to the product criterion ‘Product Components’ based on a product parameter, such as packaging of the solution of the product, that is, whether the product has separate components or modules so that each component/module can be used independently. Taking an example of Business Intelligence (BI) products, (Extract, Transform, and Load) ETL and Reporting Components could be used separately and standalone. In an example, if the OSS product has separate modules/components that can be used independently, then the scoring module 118 is configured to allot a criterion score of 1 to the product criterion ‘Product Components’. If the OSS product does not have separate modules/components that can be used independently, then a criterion score of 0 is allotted.

The scoring module 118 may be configured to allot criterion scores to the product criterion ‘Core Features’ based on the product parameters, such as all the basic features that are required for OSS product and the type of Core Features of the OSS product. For example, if the OSS product provides product category ‘Product Offerings’ having product criterion ‘Core Features’ that has out-of-the-box offerings, then the scoring module 118 is configured to allot a criterion score of 3 to the ‘Core Features’ product criterion. If the product category ‘Product Offerings’ of the OSS product has product criterion ‘Core Features’ that meets criteria with third-party plug-in integration, then the scoring module 118 is configured to allot a criterion score of 2 and if the OSS product has core features where a proper customization is required, then the scoring module 118 is configured to allot a criterion score of 1.

Furthermore, the scoring module 118 is configured to allot criterion scores to the product criterion ‘Advanced Features’ based on product parameters, such as Monitoring, Reporting, Analytics and the like, of the OSS product including the product criterion ‘Core Features’. As indicated earlier, a user may access and operate the assessment system 102. In one implementation, the scoring module 118 may be configured to receive different types of core features and advanced features from a user based on the type of the OSS product. The user may be an assessor, such as a technologist.

Similarly, the scoring module 118 is configured to allot criterion scores to each of the product criterions based on the plurality of pre-defined product parameters. The scoring module 118 may be configured to allot criterion scores to the product criterion ‘Latest Version’ based on a product parameter, such as details of the version and release date of the OSS Product to check if there are any regular stable releases and recent releases. The regular stable releases and recent releases indirectly give the message that there is active involvement by open source community to enrich the product features.

Similarly criterion scores are allotted to the product criterions ‘History’, ‘Product Technology’, ‘Certifications’, ‘Product Deployment’, and ‘Product Competition’ based on product parameters, such as details of any specific leadership/architectural change/takeover or mergers, the technology stack used in product architecture based on the open standards and inter-operable, checking if some third party vendors like open logic have certified the OSS product to be used in enterprises, whether the product has been deployed successfully in production for various large customers and for large user base, and competitors to the OSS product in their domain, respectively.

Furthermore, the criterion scores are allotted to the product criterions ‘Product Roadmap’, ‘Technology Partner’, ‘Solution Partner’, ‘System Integrator Partner’, and ‘Analyst Endorsement’ based on the product parameters, such as a product parameter, product roadmap/Vision for the next 3 years in terms of product enhancements/adoption of new technology trends/adoption of new complex business requirements, support to the OSS product by big technology vendors, say, Microsoft®, to enhance the product, whether the product has jointly tied up with some industry to come up with industry Solution offerings, evaluating the OSS product based on who the integrator partners are and whether the Integrator Partners are big technology companies or small technology companies, have partnerships/alliances with this open source product, and evaluation based on whether the OSS product is endorsed by any analyst firm, respectively.

The scoring module 118 may further be configured to allot criterion scores to the product criterions ‘Architecture Principles’ and ‘Industry Standards Compliance for Interoperability’ based on product parameters, such as architecture principles on which the OSS Product is built and future feature extensions, adoption, and integration with variety of technologies and checking whether the OSS product architecture complies with various industry standards so that product code of the OSS Product could be easily deployed without code change in multiple environments, respectively.

Similarly the criterion scores are allotted to product criterions ‘Platform Support/Portability’, ‘Security’, ‘Usability’, ‘Performance’, ‘Scalability’, ‘Extensibility’, ‘Integration’, and ‘Maintainability’ based on product parameters, such as to check if the product supports all major software infrastructure components such as application servers, database browsers etc., different kinds of measures have been provided by the OSS product to handle secured application access and data access, and what solutions are available for authentication and authorization that can seamlessly integrate with existing enterprise solutions, how user-friendly the OSS product is to the end-user and whether the end-user could use the product with a minimal training, respectively.

Furthermore, the criterion scores are allotted to the product criterions ‘Performance’, ‘Scalability’, and ‘Extensibility’ based on product parameters, such as the response time of application for large volumes of data and concurrent usage, the vertical and horizontal capability of the product, and whether the OSS product has a framework/design to extend existing features of the product or not, respectively. The criterion scores are allotted to the product criterions ‘Integration’ and ‘Maintainability’ based on product parameter, such as whether the OSS product could be easily integrated with any third party components/applications for exchange of data and how easily new enhancements or change in environment could be handled by the OSS product, respectively.

For the product criterions ‘Product Documentation’ and the ‘Ease of Development Community Strength’, criterion scores are allotted based on availability of quality documentation at zero cost for the OSS product and also to assess whether the documentation standard is up to the mark and availability of Integrated Development Environment (IDEs) for ease of development, respectively. Similarly for the product criterions ‘Community Strength’, ‘Training’, and ‘Professional Services’, the criterion scores are allotted based on strength of the user community and how strong the user community is, availability of training services, and availability of professional services available for the OSS product.

Moreover, criterion scores may be allotted to the product criterions ‘Licensing’, ‘Cost’, and ‘Warranty/Indemnity Coverage’, based on product parameters, such as whether the licenses are permissive licenses such as Apache, MIT, BSD and the like, or weak Copyleft licenses such as LGPL, MPL and the like, or strong Copyleft licenses such as GPL and the like, whether the OSS product is an Enterprise/OEM model that involves a certain amount of fee, or if the OSS product is a community edition free usage that involves no cost, and indemnification service that are available for EE/OEM in any form, respectively.

According to an example, the criterion scores allotted to each of the product criterions associated with each of the product categories are depicted in Table 1 (provided below). According to said example, the product categories may be six in number. The six product categories may be the ‘About Product’ category, the ‘Product Strategy’ category, the ‘Product Offerings’ category, the ‘Product Architecture’ category, the ‘Product Support’ category, and the ‘Commercials’ category.

TABLE 1

| Product | | | Criterion |
|---|---|---|---|
| Category | Product Criterion | Product Parameter | Score |
| About Product | Launch Year | Product is in market for more than 5 | 3 |
| | | Years | |
| | Launch Year | Product is in market for 2 to 5 Years | 2 |
| | Launch Year | Product is in Market for less than 2 | 1 |
| | | Years | |
| | Latest Version/ | Timeline for release <3 Months or | 3 |
| | Release Date | less | |
| | Latest Version/ | Timeline for releases >6 Months | 2 |
| | Release Date | and <12 Months | |
| | Latest Version/ | Timeline for releases >12 Months | 1 |
| | Release Date | | |
| | History | Something significant has happened | 1 |
| | | in a positive direction | |
| | History | Something significant has happened | 0 |
| | | in a negative direction | |
| | Product Technology | Product is based on open standards | 1 |
| | | and can easily be extended, | |
| | | integrated and deployed in custom | |
| | | applications/products. | |
| | Product Technology | Product has proprietary components | 0 |
| | | and requires use of non-standard | |
| | | technology, which adds to learning | |
| | | time and hits productivity | |
| | Product Components | Product has separate | 1 |
| | | modules/components which can be | |
| | | used independently | |
| | Product Components | Product components/modules cannot | 0 |
| | | be used independently | |
| | Certifications | Product is certified | 1 |
| | Certifications | Product is not certified | 0 |
| | Production | Case study is available for Fortune | 3 |
| | Deployment(s) | 500 companies with 10,000 + user | |
| | | base | |
| | Production | Case study is available for Medium | 2 |
| | Deployment(s) | Size Companies with 2000 to 5000 | |
| | | user base | |
| | Production | Case study is available for Small | 1 |
| | Deployment(s) | Size Companies with user base less | |
| | | than 2000 | |
| | Product Competition | Open source product (OSS) has a | 3 |
| | | USP (Unique Selling Point) for any | |
| | | particular area/feature which other | |
| | | open source/commercial products do | |
| | | not have and has almost comparable | |
| | | features. | |
| | Product Competition | No specific USP, but basic features | 2 |
| | | (80/20 Principle) are available | |
| | Product Competition | No specific USP and feature set is | 1 |
| | | also not comparable with other | |
| | | competitors | |
| Product | Product Roadmap | OSS Product has a strong Roadmap | 3 |
| Strategy | | addressing, both Functional & | |
| | | Technical Gaps with stringent | |
| | | timelines to meet it. | |
| | Product Roadmap | OSS Product has a Roadmap but | 2 |
| | | with longer timelines to meet the | |
| | | functional/Technical gaps | |
| | Product Roadmap | OSS Product has no Roadmap | 1 |
| | | Published and no active contribution | |
| | | by OSS community | |
| | Technology Partner | Support from big Vendors | 2 |
| | Technology Partner | Support from small/medium size | 1 |
| | | vendors/peers | |
| | Technology Partner | No Support | 0 |
| | Solution Partner | Support from big Vendors | 2 |
| | Solution Partner | Support from small/medium size | 1 |
| | | vendors/peers | |
| | Solution Partner | No Support | 0 |
| | System Integrator | Big IT Organizations | 2 |
| | Partner | | |
| | System Integrator | Other Smaller IT Organizations | 1 |
| | Partner | | |
| | System Integrator | No Partnership | 0 |
| | Partner | | |
| | Analyst Endorsement | Multiple Analyst Firms have positive | 2 |
| | | recommendations | |
| | Analyst Endorsement | At least one analyst firm has positive | 1 |
| | | recommendation | |
| | Analyst Endorsement | No Recommendation from any | 0 |
| | | analyst Firm | |
| Product | Core Features | Meets Criteria Out-of-Box | 3 |
| Offerings | Core Features | Meets Criteria with Third Party | 2 |
| | | Plug-In Integration | |
| | Core Features | Customization Required | 1 |
| | Advanced Features | Meets Criteria Out-of-Box | 3 |
| | Advanced Features | Meets Criteria with Third Party | 2 |
| | | Plug-In Integration | |
| | Advanced Features | Customization Required | 1 |
| Product | Architecture Principles | Flexible Loosely Coupled | 1 |
| Architecture | | Architecture for | |
| | | embedding/deploying in products | |
| | Architecture Principles | Tightly Coupled Architecture | 0 |
| | Industry Standards | Complies with all industry standard | 1 |
| | Compliance for | requirements | |
| | Interoperability | | |
| | Industry Standards | Does not comply with industry | 0 |
| | Compliance for | standards | |
| | Interoperability | | |
| | Platform Support/ | Supports all Major Platforms (Open | 2 |
| | Portability | source/Commercial) used in Industry | |
| | Platform Support/ | Have support for limited Platforms | 1 |
| | Portability | | |
| | Security | Sophisticated Security Measurement | 2 |
| | | solutions | |
| | Security | Very Basic Security Solutions | 1 |
| | Usability | Rich User Experience | 2 |
| | Usability | Difficult to understand and use the | 1 |
| | | application | |
| | Performance | Solution has proven performance | 2 |
| | | benchmark results available | |
| | Performance | Solution has not demonstrated usage | 1 |
| | | in extreme data volume requirements | |
| | Scalability | Solution has proven capability in this | 2 |
| | | area | |
| | Scalability | Solution has not demonstrated this | 1 |
| | | capability | |
| | Extensibility | Solution has an easy to use | 2 |
| | | Extension Environment | |
| | Extensibility | Solution does not have Extension | 1 |
| | | Environment | |
| | Integration | Solution Provides for Integration by | 1 |
| | | providing APIs/Web Services/ETL | |
| | Integration | Solution does not provide an | 0 |
| | | Integration Environment | |
| | Maintainability | Solution has a very well defined | 2 |
| | | process to maintain/enhance/upgrade | |
| | | product | |
| | Maintainability | Difficult to maintain product | 1 |
| Product | Product | Quality Documentation Easily | 2 |
| Support | Documentation | Available at Zero Cost | |
| | Product | Documentation Standard Not up to | 1 |
| | Documentation | Mark | |
| | Ease of Development | IDEs available for quick | 2 |
| | | development | |
| | Ease of Development | No IDE available for development | 1 |
| | | work | |
| | Community Strength | Strong User Community - 10,000+ | 3 |
| | Community Strength | Medium User Community - 3000 to | 2 |
| | | 10,000 | |
| | Community Strength | Low User Community - <3000 | 1 |
| | Training | Training Services Available | 1 |
| | Training | No Training Services Available | 0 |
| | Professional Services | Professional Services Available | 1 |
| | Professional Services | No Professional Services Available | 0 |
| Commercials | Licensing | Permissive licenses | 2 |
| | Licensing | Weak Copyleft Licenses | 1 |
| | Licensing | Strong Copyleft Licenses | 0 |
| | Cost | Community Edition Free Usage, No | 1 |
| | | Cost | |
| | Cost | Enterprise/OEM Model, Fee | 0 |
| | | Involved | |
| | Warranty/ | Indemnification Services are | 1 |
| | Indemnification | Available for EE/OEM | |
| | Coverage | | |
| | Warranty/ | Indemnification Services are not | 0 |
| | Indemnification | Available in any form | |
| | Coverage | | |

As shown in the Table 1 above, criterion scores are allotted to each of the product criterions of the six product categories based on certain product parameters.

### Assignment of Weight to Each Product Criterion

Once the criterion scores are allotted, the assigning module 120 is configured to assign a weight to each of the product criterions based on inputs from an assessor, hereinafter referred to as assessor input. The weights may be assigned based on user's requirement or significance of each of the product criterions on the one or more product categories. In one implementation, the assigning module 120 may be configured to receive assessor input to assign weight to each of the product criterions. In an example, if for the assessor, the product criterion ‘Product Technology’ is most relevant with respect to product category ‘About Product’, then the assessor may provide a weight of 5. In another example, if the product criterion ‘Product Technology’ is least relevant, then a weight of 2 may be assigned.

According to an example, the weight assigned to each of the product criterions based on the assessor input is depicted in Table 2 (provided below). According to said example, the weight from 0 to 5 may be assigned based on assessor input.

TABLE 2

| Product Category | Product Criterion | Weight |
|---|---|---|
| About Product | Launch Year | 2 |
| | Latest Version/Release Date | 3 |
| | History | 2 |
| | Product Technology | 5 |
| | Product Components | 4 |
| | Certifications | 3 |
| | Production Deployment(s) | 4 |
| | Product Competition | 3 |
| Product Strategy | Product Roadmap | 4 |
| | Technology Partner | 3 |
| | Solution Partner | 3 |
| | System Integrator Partner | 3 |
| | Analyst Endorsement | 4 |
| Product Offerings | Core Features | 5 |
| | Advanced Features | 3 |
| Product Architecture | Architecture Principles | 5 |
| | Industry Standards Compliance | 5 |
| | for Interoperability | |
| | Platform Support/Portability | 5 |
| | Security | 4 |
| | Usability | 4 |
| | Performance | 4 |
| | Scalability | 4 |
| | Extensibility | 5 |
| | Integration | 4 |
| | Maintainability | 3 |
| Product Support | Product Documentation | 4 |
| | Ease of Development | 4 |
| | Community Strength | 4 |
| | Training | 3 |
| | Professional Services | 3 |
| Commercials | Licensing | 5 |
| | Cost | 5 |
| | Warranty/Indemnification | 5 |
| | Coverage | |

As shown in the Table 2 above, weight is assigned to each of the product criterion of each of the product categories based on user's requirement. In one implementation, the weights assigned by the assigning module 120 may be modified as per the requirement of the user.

### Generation of an Ideal and a Benchmark Scorecard

Upon assigning of the weights, the generation module 122 may be configured generate an ideal scorecard and a benchmark scorecard for the OSS product. The ideal scorecard may be indicative of total ideal score, i.e., the cumulative sum of ideal scores of all product categories and the benchmark scorecard may be indicative of total benchmark score, i.e., cumulative sum of benchmark scores of all the product categories. The ideal score may be understood as a best possible score for a product in a product category, and the benchmark score may be understood as a reference score for a product in a product category against which the product can be assessed for selection.

In one implementation, the generation module 122 may be configured to select criterion scores from amongst the allotted criterion scores and calculate a weighted score for each of the product criterions based on the selected criterion scores and the weight of each of the product criterions. Thus, if the weights are modified by the assessor or the end user, the benchmark scores and the ideal scores may also change.

In case of generation of the ideal scorecard, the generation module 122 may be configured to select a criterion score which is the best score from amongst the allotted criterion scores for each of the product criterions. In one example, if for a product technology, the allotted criterion scores are 3, 2, and 1 then the criterion score 3 is the best score.

In an example, if the criterion scores allotted to the product criterion ‘Launch Year’ are 1, 2 and 3, and the weight 2 is assigned, then the generation module 122 may be configured to select the criterion score 3. Further, the generation module 122 may be configured to calculate the weighted score for each of the product criterions based on the selected criterion scores and the weight assigned to each of the product criterions. The weighted score may be calculated by multiplying the selected criterion score and the assigned weight. In the said example, the generation module 122 may be configured to calculate the weighted score of 6 (2×3). The generation module 122 may further be configured to add the weighted scores of each of the product criterions of each of the product categories to get an ideal score for each product category.

According to an example, the calculated weighted score for each of the product criterions and the calculated ideal score for each product category based on the weighted scores is depicted in Table 3 (provided below).

TABLE 3

| Product | Product | | | Criterion | Weighted | Ideal |
|---|---|---|---|---|---|---|
| Category | Criterion | Weight | Product Parameter | Score | Score | Score |
| About | Launch Year | 2 | Product is in market | 3 | 6 | 50 |
| Product | | | for more than 5 Years | | | |
| | Latest | 3 | Timeline for release <3 | 3 | 9 | |
| | Version/Release | | Months or less | | | |
| | Date | | | | | |
| | History | 2 | Something significant | 1 | 2 | |
| | | | has happened in a | | | |
| | | | positive direction | | | |
| | Product | 5 | Product is based on | 1 | 5 | |
| | Technology | | open standards and | | | |
| | | | can easily be | | | |
| | | | extended, integrated | | | |
| | | | and deployed in | | | |
| | | | custom applications/ | | | |
| | | | Products. | | | |
| | Product | 4 | Product has separate | 1 | 4 | |
| | Components | | modules/components | | | |
| | | | which can be used | | | |
| | | | independently | | | |
| | Certifications | 3 | Product is certified | 1 | 3 | |
| | Production | 4 | Case study is | 3 | 12 | |
| | Deployment(s) | | available for Fortune | | | |
| | | | 500 companies with | | | |
| | | | 10,000 + user base | | | |
| | Product | 3 | Open source product | 3 | 9 | |
| | Competition | | (OSS) has a USP | | | |
| | | | (Unique Selling | | | |
| | | | Point) for any | | | |
| | | | particular area/feature | | | |
| | | | which other open | | | |
| | | | source/commercial | | | |
| | | | products do not have | | | |
| | | | and has almost | | | |
| | | | comparable features. | | | |
| Product | Product | 4 | OSS Product has a | 3 | 12 | 34 |
| Strategy | Roadmap | | strong Roadmap | | | |
| | | | addressing, both | | | |
| | | | Functional & | | | |
| | | | Technical Gaps with | | | |
| | | | stringent timelines to | | | |
| | | | meet it. | | | |
| | Technology | 3 | Support from big | 2 | 6 | |
| | Partner | | Vendors | | | |
| | Solution | 3 | Support from big | 2 | 6 | |
| | Partner | | Vendors | | | |
| | System | 3 | Big IT Organizations | 2 | 6 | |
| | Integrator | | | | | |
| | Partner | | | | | |
| | Analyst | 4 | At least one analyst | 1 | 4 | |
| | Endorsement | | firm has positive | | | |
| | | | recommendation | | | |
| Product | Core | 5 | Meets Criteria Out- | 3 | 15 | 24 |
| Offerings | Features | | of-Box | | | |
| | Advanced | 3 | Meets Criteria Out- | 3 | 9 | |
| | Features | | of-Box | | | |
| Product | Architecture | 5 | Flexible Loosely | 1 | 5 | 67 |
| Architecture | Principles | | Coupled Architecture | | | |
| | | | for | | | |
| | | | embedding/deploying | | | |
| | | | in products | | | |
| | Industry | 5 | Complies with all | 1 | 5 | |
| | Standards | | industry standard | | | |
| | Compliance | | requirements | | | |
| | for | | | | | |
| | Interoperability | | | | | |
| | Platform | 5 | Supports all Major | 2 | 10 | |
| | Support/Portability | | Platforms (Open | | | |
| | | | source/Commercial) | | | |
| | | | used in | | | |
| | Security | 4 | Sophisticated | 2 | 8 | |
| | | | Security | | | |
| | | | Measurement | | | |
| | | | solutions | | | |
| | Usability | 4 | Rich User Experience | 2 | 8 | |
| | Performance | 4 | Solution has proven | 2 | 8 | |
| | | | performance | | | |
| | | | benchmark results | | | |
| | | | available | | | |
| | Scalability | 4 | Solution has proven | 2 | 8 | |
| | | | capability in this area | | | |
| | Extensibility | 5 | Solution has an easy | 2 | 10 | |
| | | | to use Extension | | | |
| | | | Environment | | | |
| | Integration | 4 | Solution Provides for | 1 | 4 | |
| | | | Integration by | | | |
| | | | providing APIs/Web | | | |
| | | | Services/ETL | | | |
| | Maintainability | 3 | Solution has a very | 2 | 6 | |
| | | | well defined process | | | |
| | | | to | | | |
| | | | maintain/enhance/upgrade | | | |
| | | | product | | | |
| Product | Product | 4 | Quality | 2 | 8 | 34 |
| Support | Documentation | | Documentation | | | |
| | | | Easily Available at | | | |
| | | | Zero Cost | | | |
| | Ease of | 4 | IDEs available for | 2 | 8 | |
| | Development | | quick development | | | |
| | Community | 4 | Strong User | 3 | 12 | |
| | Strength | | Community - 10,000+ | | | |
| | Training | 3 | Training Services Available | 1 | 3 | |
| | Professional | 3 | Professional Services | 1 | 3 | |
| | Services | | Available | | | |
| Commercials | Licensing | 5 | Permissive licenses | 2 | 10 | 20 |
| | Cost | 5 | Community Edition | 1 | 5 | |
| | | | Free Usage, No Cost | | | |
| | Warranty/ | 5 | Indemnification | 1 | 5 | |
| | Indemnification | | Services are | | | |
| | Coverage | | Available for | | | |
| | | | EE/OEM | | | |

| | |
|---|---|
| TOTAL IDEAL SCORE | 229 |

As shown in the Table 3 above, criterion score which is the best score is selected for each of the product criterions and based on the selected score and the weight, weighted score is calculated for each product criterion by multiplication of the selected criterion score and the weight. Further, ideal score of each of the product categories is calculated based on summation of the weighted scores of each of the product criterions. As is evident from the above table, for the product criterions ‘Licensing’, ‘Cost’, and ‘Warranty/Indemnification Coverage’, criterion scores 2, 1, and 1 are selected, respectively, and weight of 5 is assigned to each of the product criterions. It is also evident from the above table, the weighted score calculated for the product criterions ‘Licensing’, ‘Cost’, and ‘Warranty/Indemnification Coverage’ are 10 (5×2), 5 (5×1), and 5(5×1), respectively, and the ideal score for the product category ‘Commercials’ is 20, i.e., summation of weighted scores 10, 5, and 5. Further, the total ideal score is 229. Similarly, the generation module 122 may be configured to generate the benchmark scorecard by selecting a criterion score which is a reference score for a product in a product category against which the product can be assessed for selection.

Now, if the criterion scores allotted to the product criterion ‘Launch Year’ are 1, 2 and 3, and the weight 2 is assigned, then the generation module 122 may be configured to select the criterion score 2. Further, the generation module 122 may be configured to calculate the weighted score for each of the product criterions based on the selected criterion scores and weight assigned to each of the product criterions. The weighted score may be calculated by multiplying the selected criterion score and the assigned weight. In the said example, the generation module 122 may be configured to calculate the weighted score of 4 (2×2). The generation module 122 may further be configured to add the weighted scores of each of the product criterions associated with each of the product categories to obtain a benchmark score for each product category.

In one implementation, the generation module 122 may store the generated ideal and benchmark scorecards as the scorecard data 132 in the local memory of the assessment system 102.

According to an example, the calculated weighted score for each of the product criterions and the calculated benchmark score for each product category based on the weighted scores is depicted in Table 4 (provided below).

TABLE 4

| Product | Product | | Product | Criterion | Weighted | Benchmark |
|---|---|---|---|---|---|---|
| Category | Criterion | Weight | Parameter | Score | Score | Score |
| About | Launch Year | 2 | Product is in market for | 2 | 4 | 33 |
| Product | | | 2 to 5 Years | | | |
| | Latest Version/ | 3 | Timeline for release >6 | 2 | 6 | |
| | Release Date | | and <12 Months | | | |
| | History | 2 | Something significant has | 0 | 0 | |
| | | | happened in a negative | | | |
| | | | direction | | | |
| | Product | 5 | Product is based on open | 1 | 5 | |
| | Technology | | standards and can easily | | | |
| | | | be extended, integrated | | | |
| | | | and deployed in custom | | | |
| | | | applications/Products. | | | |
| | Product | 4 | Product has separate | 1 | 4 | |
| | Components | | modules/components which | | | |
| | | | can be used independently | | | |
| | Certifications | 3 | Product is not certified | 0 | 0 | |
| | Production | 4 | Case study is available | 2 | 8 | |
| | Deployment(s) | | for Fortune 500 companies | | | |
| | | | with 2000 to 5000 user | | | |
| | | | base | | | |
| | Product | 3 | Open source product (OSS) | 2 | 6 | |
| | Competition | | has no specific USP | | | |
| | | | (Unique Selling Point) | | | |
| Product | Product Roadmap | 4 | OSS Product has a strong | 2 | 8 | 17 |
| Strategy | | | Roadmap addressing, both | | | |
| | | | Functional & Technical | | | |
| | | | Gaps with stringent | | | |
| | | | timelines to meet it. | | | |
| | Technology | 3 | Support from small/medium | 1 | 3 | |
| | Partner | | size Vendors | | | |
| | Solution Partner | 3 | Support from small/medium | 1 | 3 | |
| | | | size Vendors | | | |
| | System | 3 | Smaller IT Organizations | 1 | 3 | |
| | Integrator | | | | | |
| | Partner | | | | | |
| | Analyst | 4 | No recommendation from | 0 | 0 | |
| | Endorsement | | any analyst firm | | | |
| Product | Core Features | 5 | Meets Criteria with Third | 2 | 10 | 16 |
| Offerings | | | Party Plug-In Integration | | | |
| | Advanced | 3 | Meets Criteria with Third | 2 | 6 | |
| | Features | | Party Plug-In Integration | | | |
| Product | Architecture | 5 | Flexible Loosely Coupled | 1 | 5 | 38 |
| Architecture | Principles | | Architecture for embedding/ | | | |
| | | | deploying in products | | | |
| | Industry Standards | 5 | Complies with all industry | 1 | 5 | |
| | Compliance for | | standard requirements | | | |
| | Interoperability | | | | | |
| | Platform Support/ | 5 | Supports from limited | 1 | 5 | |
| | Portability | | Platforms | | | |
| | Security | 4 | Very Basic Security Solutions | 1 | 4 | |
| | Usability | 4 | Difficult to understand and | 1 | 4 | |
| | | | use the application | | | |
| | Performance | 4 | Solution has not demonstrated | 1 | 4 | |
| | | | usage in extreme volume | | | |
| | | | requirements | | | |
| | Scalability | 4 | Solution has not demonstrated | 1 | 4 | |
| | | | this capability | | | |
| | Extensibility | 5 | Solution does not have | 1 | 5 | |
| | | | Extension Environment | | | |
| | Integration | 4 | Solution Provides for | 1 | 4 | |
| | | | Integration by providing | | | |
| | | | APIs/Web Services/ETL | | | |
| | Maintainability | 3 | Difficult to maintain product | 1 | 3 | |
| | | | upgrade product | | | |
| Product | Product | 4 | Documentation Standard Not up | 1 | 4 | 16 |
| Support | Documentation | | to Mark | | | |
| | Ease of | 4 | No IDE available for | 1 | 4 | |
| | Development | | development work | | | |
| | Community Strength | 4 | Medium User Community - 3000 | 2 | 8 | |
| | | | to 10,000 | | | |
| | Training | 3 | No Training Services | 0 | 0 | |
| | | | Available | | | |
| | Professional Services | 3 | No Professional Services | 0 | 0 | |
| | | | Available | | | |
| Commercials | Licensing | 5 | Weak Copyleft Licenses | 1 | 5 | 15 |
| | Cost | 5 | Community Edition Free Usage, | 1 | 5 | |
| | | | No Cost | | | |
| | Warranty/ | 5 | Indemnification Services are | 1 | 5 | |
| | Indemnification | | Available for EE/OEM | | | |
| | Coverage | | | | | |

| | |
|---|---|
| TOTAL BENCHMARK SCORE | 135 |

As shown in the Table 4 above, criterion score which is a reference score is selected for each of the product criterions and based on the selected criterion score and the assigned weight, weighted score is calculated for each of the product criterions. Further, benchmark score of each product of the categories is calculated based on summation of the weighted scores of each of the product criterions associated with each of the product categories. As is evident from the above table, for the product criterions ‘Licensing’, ‘Cost’, and ‘Warranty/Indemnification Coverage’, criterion scores 1, 1, and 1 are selected, respectively, and weight of 5 is assigned to each of the product criterion.

It is also evident from the above table, the weighted score calculated for the product criterions ‘Licensing’, ‘Cost’, and ‘Warranty/Indemnification Coverage’ are 5 (5×1), (5×1), and 5(5×1), and the benchmark score for the product category ‘Commercials’ is 15, i.e., summation of weighted scores 5, 5, and 5. Further, the total benchmark score is 135.

### Receiving Ratings from a User for Each of the Product Criterions for a Plurality of OSS Products

Subsequent to generation of the ideal and benchmark scorecards, the computation module 124 may be configured to retrieve product data 130 associated with a plurality of OSS products from the data 116. Further, the computation module 124 may be configured to receive core features and advanced features from the assessor for the product criterions ‘Core Features’ and ‘Advanced Features’ based on the type of the OSS product. In an example, if the OSS product is Enterprise Portal, then features like Single Sign On, Personalization, Workflow, and Content Management may be the core features and features like Collaboration, Bulk Migration, and Integration with Editors like Microsoft Office may be advanced features. In another example, if the OSS product is Business Process Management (BPM), then features like Business Process Orchestration, Business Rules Support, Language Support like BPMN/BPEL, and Availability of Development Tool may be the core features and Complex Event Processing Support, Process Analytics, and Process Versioning may be the advanced features.

The description hereinafter is explained with reference to the core features and the advanced features of same type of OSS products only for the purpose of explanation, and it should not be construed as a limitation, it is well appreciated that the core features and the advanced features may be different for different types of OSS products.

Furthermore, the computation module 124 may be configured to receive a rating from the assessor for each of the product criterions associated with each of the plurality of OSS products. The ratings may be received based on the plurality of pre-defined product parameters. In an example, the computation module 124 may be configured to receive ratings for three OSS products, namely product 1, product 2, and product 3 may be received from the assessor.

Taking an example of product 1 which is in market for more than 5 years, for the product criterion ‘Launch Year’, the rating of 3 may be received by the computation module 124 based on the product parameter, that is, product is in market for more than 5 years. In another example, if the product 2 is in market for less than 2 years, then rating of 1 is received for the product criterion ‘Launch Year’.

### Creation of Product Scorecard for Each of the Plurality of OSS Products

Based on the received ratings, the computation module 124 may be configured to create a product scorecard for each of the plurality of OSS products. The product scorecard for an OSS product may be indicative of a total product score, i.e., cumulative sum of product scores of all the product categories. The product score for each category is calculated based on computing product weighted score for each of the product criterions associated with each of the product categories.

For computation of the product weighted score for a product criterion, the computation module 124 may be configured to multiply the received rating with the assigned weight of the product criterion. For, example, if the rating of 3 is received and the weight 2 is assigned, then the product weighted score of 6 (3×2) is computed. Further, the computation module 124 adds the product weighted scores of each of the product criterions of each of the product categories to obtain a product score for each product category. In one implementation, the computation module 124 may store the generated product scorecards as the scorecard data 132 in the local memory of the assessment system 102.

According to an example, the ratings received and product score calculated for product 1, 2, and 3 are depicted in Tables 5, 6, and 7, respectively (provided below). The product parameters for product criterions ‘Core Features’ and ‘Advanced Features’ have been left blank in the tables; it will be explained later, in Tables 8, 9, and 10.

TABLE 5

| | | | | | Product | |
|---|---|---|---|---|---|---|
| Product | Product | | | | Weighted | Product |
| Category | Criterion | Weight | Product Parameter | Rating | Score | Score |
| About | Launch Year | 2 | Product is in market for more | 3 | 6 | 37 |
| Product | | | than 5 Years | | | |
| | Latest Version/ | 3 | Timeline for release >12 | 1 | 3 | |
| | Release Date | | Months | | | |
| | History | 2 | Something significant has | 1 | 2 | |
| | | | happened in a positive | | | |
| | | | direction | | | |
| | Product Technology | 5 | Product is based on open | 1 | 5 | |
| | | | standards and can easily be | | | |
| | | | extended, integrated and | | | |
| | | | deployed in custom | | | |
| | | | applications/Products. | | | |
| | Product Components | 4 | Product modules/components | 0 | 0 | |
| | | | cannot be used independently | | | |
| | Certifications | 3 | Product is certified | 1 | 3 | |
| | Production | 4 | Case study available for | 2 | 8 | |
| | Deployment(s) | | Medium Size Companies with | | | |
| | | | 2000 to 5000 user base | | | |
| | Product | 3 | Open source product (OSS) has | 3 | 9 | |
| | Competition | | a USP (Unique Selling Point) | | | |
| | | | for any particular area/ | | | |
| | | | feature which other open | | | |
| | | | source/commercial products do | | | |
| | | | not have and has almost | | | |
| | | | comparable features. | | | |
| Product | Product Roadmap | 4 | OSS Product has a strong | 3 | 12 | 14 |
| Strategy | | | Roadmap addressing, both | | | |
| | | | Functional & Technical Gaps | | | |
| | | | with stringent timelines to | | | |
| | | | meet it. | | | |
| | Technology Partner | 3 | No Support from big Vendors | 0 | 0 | |
| | Solution Partner | 3 | No Support from big Vendors | 0 | 0 | |
| | System Integrator | 3 | Big IT Organizations | 2 | 6 | |
| | Partner | | | | | |
| | Analyst | 4 | No recommendation from any | 0 | 0 | |
| | Endorsement | | analyst firm | | | |
| Product | Core Features | 5 | | 3 | 15 | 16 |
| Offerings | Advanced Features | 3 | | 2 | 6 | |
| Product | Architecture | 5 | Tightly Coupled Architecture | 0 | 0 | 46 |
| Architecture | Principles | | | | | |
| | Industry Standards | 5 | Does not comply with industry | 0 | 0 | |
| | Compliance for | | standards | | | |
| | Interoperability | | | | | |
| | Platform Support/ | 5 | Have support for limited | 1 | 5 | |
| | Portability | | Platforms | | | |
| | Security | 4 | Very Basic Security Solutions | 1 | 4 | |
| | Usability | 4 | Difficult to understand and | 1 | 4 | |
| | | | use the application | | | |
| | Performance | 4 | Solution has not demonstrated | 1 | 4 | |
| | | | usage in extreme volume | | | |
| | | | requirements | | | |
| | Scalability | 4 | Solution has proven capability | 2 | 8 | |
| | | | in this area | | | |
| | Extensibility | 5 | Solution has an easy to use | 2 | 10 | |
| | | | Extension Environment | | | |
| | Integration | 4 | Solution does not provide an | 0 | 0 | |
| | | | Integration Environment | | | |
| | Maintainability | 3 | Difficult to maintain product | 1 | 3 | |
| Product | Product | 4 | Documentation Standard Not up | 1 | 4 | 27 |
| Support | Documentation | | to Mark | | | |
| | Ease of | 4 | No IDE available for | 1 | 4 | |
| | Development | | development work t | | | |
| | Community Strength | 4 | Strong User Community - | 3 | 12 | |
| | | | 10,000+ | | | |
| | Training | 3 | No Training Services Available | 0 | 0 | |
| | Professional | 3 | Professional Services | 1 | 3 | |
| | Services | | Available | | | |
| Commercials | Licensing | 5 | Permissive licenses | 2 | 10 | 20 |
| | Cost | 5 | Community Edition Free Usage, | 1 | 5 | |
| | | | No Cost | | | |
| | Warranty/ | 5 | Indemnification Services are | 1 | 5 | |
| | Indemnification | | Available for EE/OEM | | | |
| | Coverage | | | | | |

| | |
|---|---|
| TOTALPRODUCT1 SCORE | 156 |

TABLE 6

| | | | | | Product | |
|---|---|---|---|---|---|---|
| Product | Product | | | | Weighted | Product |
| Category | Criterion | Weight | Product Parameter | Rating | Score | Score |
| About | Launch Year | 2 | Product in Market for less | 1 | 2 | 36 |
| Product | | | than 2 Years | | | |
| | Latest Version/ | 3 | Timeline for release <3 | 3 | 9 | |
| | Release Date | | Months or less | | | |
| | History | 2 | Something significant has | 1 | 2 | |
| | | | happened in a positive | | | |
| | | | direction | | | |
| | Product Technology | 5 | Product has proprietary | 0 | 0 | |
| | | | components and requires use of | | | |
| | | | non-standard technology, | | | |
| | | | which adds to learning time & | | | |
| | | | hits productivity | | | |
| | Product Components | 4 | Product modules/components | 0 | 0 | |
| | | | cannot be used independently | | | |
| | Certifications | 3 | Product is certified | 1 | 3 | |
| | Production | 4 | Case study available for | 3 | 12 | |
| | Deployment(s) | | Fortune 500 companies with | | | |
| | | | 10,000+ user base | | | |
| | Product | 3 | Open source product (OSS) has | 3 | 9 | |
| | Competition | | a USP (Unique Selling Point) | | | |
| | | | for any particular area/ | | | |
| | | | feature which other open | | | |
| | | | source/commercial products | | | |
| | | | do not have and has almost | | | |
| | | | comparable features. | | | |
| Product | Product Roadmap | 4 | If OSS Product has a Roadmap | 2 | 8 | 18 |
| Strategy | | | but with longer timelines to | | | |
| | | | meet the functional/Technical | | | |
| | | | gaps | | | |
| | Technology Partner | 3 | No Support from big Vendors | 0 | 0 | |
| | Solution Partner | 3 | No Support from big Vendors | 0 | 0 | |
| | System Integrator | 3 | Big IT Organizations | 2 | 6 | |
| | Partner | | | | | |
| | Analyst | 4 | No recommendation | 0 | 0 | |
| | Endorsement | | from any analyst firm | | | |
| Product | Core Features | 5 | | 2 | 10 | 21 |
| Offerings | Advanced Features | 3 | | 2 | 6 | |
| Product | Architecture | 5 | Tightly Coupled Architecture | 0 | 0 | 38 |
| Architecture | Principles | | | | | |
| | Industry Standards | 5 | Does not comply with industry | 0 | 0 | |
| | Compliance for | | standards | | | |
| | Interoperability | | | | | |
| | Platform Support/ | 5 | Have support for limited | 1 | 5 | |
| | Portability | | Platforms | | | |
| | Security | 4 | Sophisticated Security | 2 | 8 | |
| | | | Measurement solutions | | | |
| | Usability | 4 | Difficult to understand and | 1 | 4 | |
| | | | use the application | | | |
| | Performance | 4 | Solution has not demonstrated | 2 | 8 | |
| | | | usage in extreme volume | | | |
| | | | requirements | | | |
| | Scalability | 4 | Solution has proven capability | 2 | 8 | |
| | | | in this area | | | |
| | Extensibility | 5 | Solution has an easy to use | 2 | 10 | |
| | | | Extension Environment | | | |
| | Integration | 4 | Solution does not provide an | 0 | 0 | |
| | | | Integration Environment | | | |
| | Maintainability | 3 | Difficult to maintain product | 1 | 3 | |
| Product | Product | 4 | Quality Documentation Easily | 2 | 8 | 23 |
| Support | Documentation | | Available at Zero Cost | | | |
| | Ease of | 4 | No IDE available for development | 1 | 4 | |
| | Development | | work t | | | |
| | Community Strength | 4 | Strong User Community - | 3 | 12 | |
| | | | 10,000+ | | | |
| | Training | 3 | No Training Services Available | 0 | 0 | |
| | Professional | 3 | Professional Services | 1 | 3 | |
| | Services | | Available | | | |
| Commercials | Licensing | 5 | Permissive licenses | 2 | 10 | 20 |
| | Cost | 5 | Community Edition Free Usage, | 1 | 5 | |
| | | | No Cost | | | |
| | Warranty/ | 5 | Indemnification Services are | 1 | 5 | |
| | Indemnification | | Available for EE/OEM | | | |
| | Coverage | | | | | |

| | |
|---|---|
| TOTAL PRODUCT 2 SCORE | 160 |

TABLE 7

| | | | | | Product | |
|---|---|---|---|---|---|---|
| Product | Product | | | | Weighted | Product |
| Category | Criterion | Weight | Product Parameter | Rating | Score | Score |
| About | Launch Year | 2 | Product in market for more | 3 | 6 | 30 |
| Product | | | than 5 Years | | | |
| | Latest Version/ | 3 | Timeline for releases >6 | 2 | 6 | |
| | Release Date | | Months & <12 Months | | | |
| | History | 2 | Something significant has | 1 | 2 | |
| | | | happened in a positive | | | |
| | | | direction | | | |
| | Product Technology | 5 | Product is based on open | 1 | 5 | |
| | | | standards and can easily be | | | |
| | | | extended, integrated and | | | |
| | | | deployed in custom | | | |
| | | | applications/Products. | | | |
| | Product Components | 4 | Product modules/components | 1 | 4 | |
| | | | can be used independently | | | |
| | Certifications | 3 | Product is not certified | 0 | 0 | |
| | Production | 4 | Case study available for Small | 1 | 4 | |
| | Deployment(s) | | Size Companies with user base | | | |
| | | | less than 2000 | | | |
| | Product | 3 | No specific USP and feature | 1 | 3 | |
| | Competition | | set also not comparable with | | | |
| | | | other competitors | | | |
| Product | Product Roadmap | 4 | If OSS Product has no Roadmap | 1 | 4 | 4 |
| Strategy | | | Published and no active | | | |
| | | | contribution by OSS community | | | |
| | Technology Partner | 3 | No Support from big Vendors | 0 | 0 | |
| | Solution Partner | 3 | No Support from big Vendors | 0 | 0 | |
| | System Integrator | 3 | No Partnership | 0 | 0 | |
| | Partner | | | | | |
| | Analyst | 4 | No recommendation from any | 0 | 0 | |
| | Endorsement | | analyst firm | | | |
| Product | Core Features | 5 | | 3 | 15 | 24 |
| Offerings | Advanced Features | 3 | | 3 | 9 | |
| Product | Architecture | 5 | Tightly Coupled Architecture | 0 | 0 | 29 |
| Architecture | Principles | | | | | |
| | Industry Standards | 5 | Does not comply with industry | 0 | 0 | |
| | Compliance for | | standards | | | |
| | Interoperability | | | | | |
| | Platform Support/ | 5 | Have support for limited | 1 | 5 | |
| | Portability | | Platforms | | | |
| | Security | 4 | Very Basic Security Solutions | 1 | 4 | |
| | Usability | 4 | Difficult to understand and | 1 | 4 | |
| | | | use the application | | | |
| | Performance | 4 | Solution has not demonstrated | 1 | 4 | |
| | | | usage in extreme volume | | | |
| | | | requirements | | | |
| | Scalability | 4 | Solution has proven capability | 1 | 4 | |
| | | | in this area | | | |
| | Extensibility | 5 | Solution does not have | 1 | 5 | |
| | | | Extension Environment | | | |
| | Integration | 4 | Solution does not provide an | 0 | 0 | |
| | | | Integration Environment | | | |
| | Maintainability | 3 | Difficult to maintain product | 1 | 3 | |
| Product | Product | 4 | Documentation Standard Not | 1 | 4 | 12 |
| Support | Documentation | | up to Mark | | | |
| | Ease of | 4 | No IDE available for | 1 | 4 | |
| | Development | | development work t | | | |
| | Community | 4 | Low User Community - <3000 | 1 | 4 | |
| | Strength | | | | | |
| | Training | 3 | No Training Services Available | 0 | 0 | |
| | Professional | 3 | Professional Services | 0 | 0 | |
| | Services | | Available | | | |
| Commercials | Licensing | 5 | Strong Copyleft Licenses | 0 | 0 | 0 |
| | Cost | 5 | Enterprise/OEM Model, Fee | 0 | 0 | |
| | | | Involved | | | |
| | Warranty/ | 5 | Indemnification Services are | 0 | 0 | |
| | Indemnification | | Available for EE/OEM | | | |
| | Coverage | | | | | |

| | |
|---|---|
| TOTAL PRODUCT 3 SCORE | 99 |

As shown in the Table 5, 6, and 7, product parameters on the basis on which ratings are received have been explained. The product scores of each OSS product for each of the product categories are also shown. As evident from the above tables, the total product scores for product 1, 2, and 3 are 156, 160, and 99, respectively.

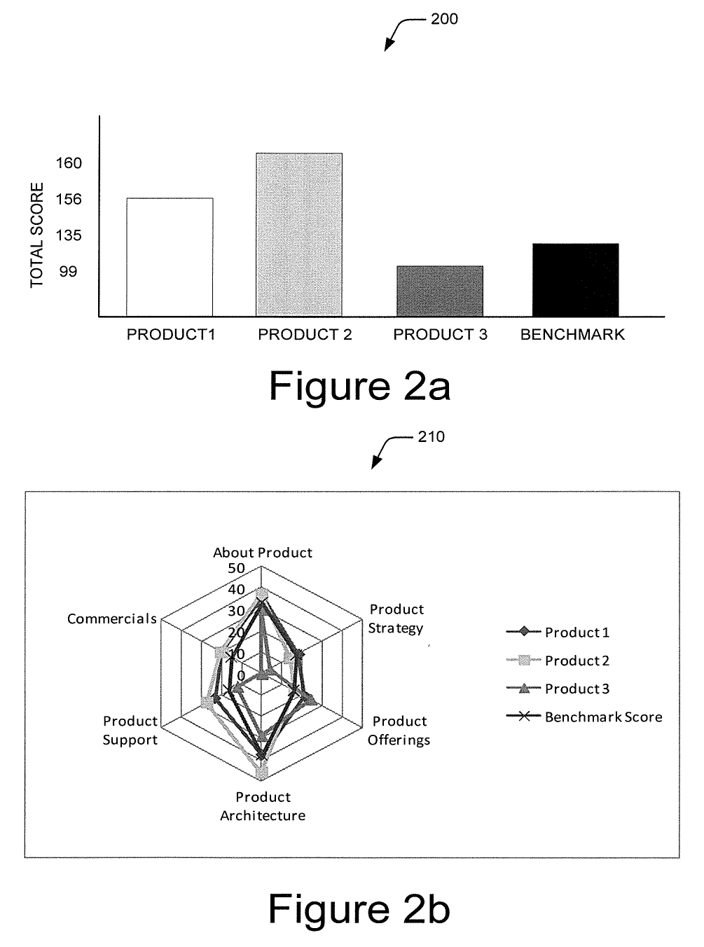

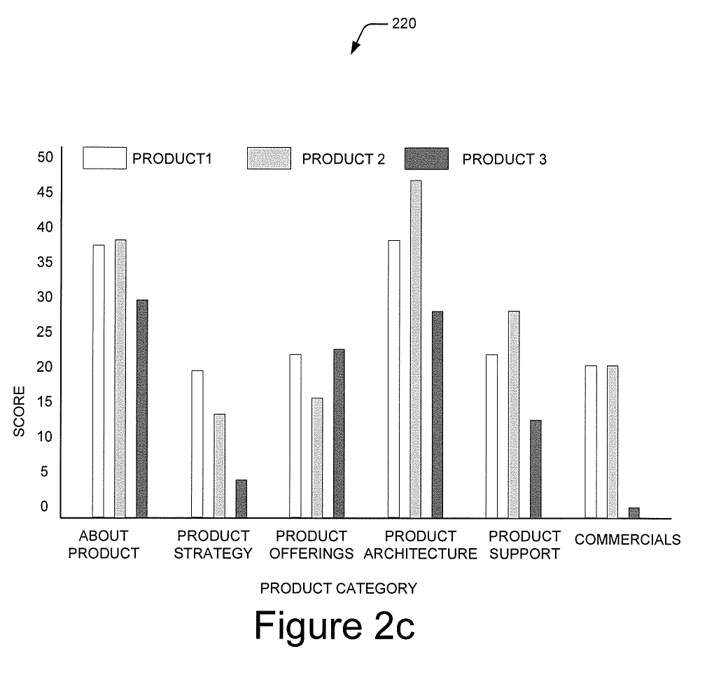

FIG. 2a illustrates an exemplary bar chart representation 200 depicting comparison of total scores attained by product 1, product 2, and product 1 with a benchmark score. As shown in FIG. 2a, total score of product 1 is 156, total score of product 2 is 160, total score of product 3 is 99, and the benchmark score is 135.

According to an example, the ratings received from the user for the product criterions ‘Core Features’ and ‘Advanced Features’ for product 1, 2, and 3 are depicted in Tables 8, 9, and 10, respectively (provided below). The product weighted scores and the product scores are also depicted in the tables. The list of core features and the advanced features may be referred to as product sub-criterions. In an example, a list of 10 core features and 5 advanced features is received for each of the products 1, 2, and 3. Further, the product parameters based on which the ratings are received from the user are also mentioned in the tables.

TABLE 8

| | | Product | | | | Product | |
|---|---|---|---|---|---|---|---|
| Product | Product | Sub- | | Product | | Weighted | Product |
| Category | Criterion | Criterion | Weight | Parameter | Rating | Score | Score |
| Product | Core | Feature 1 | 5 | Customization | 1 | 5 | 3 |
| Offerings | Features | | | Required | | | |
| | | Feature 2 | 5 | Meets Criteria | 3 | 15 | |
| | | | | Out-of-Box | | | |
| | | Feature 3 | 5 | Meets Criteria | 2 | 10 | |
| | | | | with Third Party | | | |
| | | | | Plug-In Integration | | | |
| | | Feature 4 | 5 | Customization | 1 | 5 | |
| | | | | Required | | | |
| | | Feature 5 | 5 | Customization | 1 | 5 | |
| | | | | Required | | | |
| | | Feature 6 | 5 | Meets Criteria | 2 | 10 | |
| | | | | with Third Party | | | |
| | | | | Plug-In Integration | | | |
| | | Feature 7 | 5 | Meets Criteria | 3 | 15 | |
| | | | | Out-of-Box | | | |
| | | Feature 8 | 5 | Meets Criteria | 3 | 15 | |
| | | | | Out-of-Box | | | |
| | | Feature 9 | 5 | Meets Criteria | 3 | 15 | |
| | | | | Out-of-Box | | | |
| | | Feature 10 | 5 | Customization | 1 | 5 | |
| | | | | Required | | | |
| | Advanced | Feature 1 | 3 | Customization | 1 | 3 | 2 |
| | Features | | | Required | | | |
| | | Feature 2 | 3 | Meets Criteria | 3 | 9 | |
| | | | | Out-of-Box | | | |
| | | Feature 3 | 3 | Meets Criteria | 2 | 6 | |
| | | | | with Third Party | | | |
| | | | | Plug-In Integration | | | |
| | | Feature 4 | 3 | Customization | 1 | 3 | |
| | | | | Required | | | |
| | | Feature 5 | 3 | Customization | 1 | 3 | |
| | | | | Required | | | |

TABLE 9

| | | Product | | | | Product | |
|---|---|---|---|---|---|---|---|
| Product | Product | Sub- | | Product | | Weighted | Product |
| Category | Criterion | Criterion | Weight | Parameter | Rating | Score | Score |
| Product | Core | Feature 1 | 5 | Meets Criteria | 3 | 15 | 2 |
| Offerings | Features | | | Out-of-Box | | | |
| | | Feature 2 | 5 | Customization | 1 | 5 | |
| | | | | Required | | | |
| | | Feature 3 | 5 | Customization | 1 | 5 | |
| | | | | Required | | | |
| | | | | Integration | | | |
| | | Feature 4 | 5 | Customization | 1 | 5 | |
| | | | | Required | | | |
| | | Feature 5 | 5 | Meets Criteria | 2 | 10 | |
| | | | | with Third Party | | | |
| | | | | Plug-In Integration | | | |
| | | Feature 6 | 5 | Customization | 1 | 5 | |
| | | | | Required Integration | | | |
| | | Feature 7 | 5 | Customization | 1 | 5 | |
| | | | | Required Integration | | | |
| | | Feature 8 | 5 | Customization | 1 | 5 | |
| | | | | Required Integration | | | |
| | | Feature 9 | 5 | Meets Criteria | 2 | 10 | |
| | | | | with Third Party | | | |
| | | | | Plug-In Integration | | | |
| | | Feature 10 | 5 | Meets Criteria | 3 | 15 | |
| | | | | Out-of-Box | | | |
| | Advanced | Feature 1 | 3 | Customization | 3 | 9 | 2 |
| | Features | | | Required | | | |
| | | Feature 2 | 3 | Meets Criteria | 1 | 3 | |
| | | | | Out-of-Box | | | |
| | | Feature 3 | 3 | Meets Criteria | 1 | 3 | |
| | | | | with Third Party | | | |
| | | | | Plug-In Integration | | | |
| | | Feature 4 | 3 | Customization | 1 | 3 | |
| | | | | Required | | | |
| | | Feature 5 | 3 | Customization | 2 | 6 | |
| | | | | Required | | | |

TABLE 10

| | | Product | | | | Product | |
|---|---|---|---|---|---|---|---|
| Product | Product | Sub- | | Product | | Weighted | Product |
| Category | Criterion | Criterion | Weight | Parameter | Rating | Score | Score |
| Product | Core | Feature 1 | 5 | Meets Criteria | 3 | 15 | 3 |
| Offerings | Features | | | Out-of-Box | | | |
| | | Feature 2 | 5 | Meets Criteria | 2 | 10 | |
| | | | | with Third Party | | | |
| | | | | Plug-In Integration | | | |
| | | Feature 3 | 5 | Meets Criteria | 3 | 15 | |
| | | | | Out-of-Box | | | |
| | | Feature 4 | 5 | Meets Criteria | 2 | 10 | |
| | | | | with Third Party | | | |
| | | | | Plug-In | | | |
| | | | | Integration | | | |
| | | Feature 5 | 5 | Meets Criteria | 3 | 15 | |
| | | | | Out-of-Box | | | |
| | | Feature 6 | 5 | Meets Criteria | 2 | 10 | |
| | | | | with Third Party | | | |
| | | | | Plug-In Integration | | | |
| | | Feature 7 | 5 | Meets Criteria | 2 | 10 | |
| | | | | with Third Party | | | |
| | | | | Plug-In Integration | | | |
| | | Feature 8 | 5 | Meets Criteria | 2 | 10 | |
| | | | | with Third Party | | | |
| | | | | Plug-In Integration | | | |
| | | Feature 9 | 5 | Meets Criteria | 3 | 15 | |
| | | | | Out-of-Box | | | |
| | | Feature 10 | 5 | Meets Criteria | 3 | 15 | |
| | | | | Out-of-Box | | | |
| | Advanced | Feature 1 | 3 | Customization | 3 | 9 | 3 |
| | Features | | | Required | | | |
| | | Feature 2 | 3 | Meets Criteria | 2 | 6 | |
| | | | | Out-of-Box | | | |
| | | Feature 3 | 3 | Meets Criteria | 3 | 9 | |
| | | | | with Third Party | | | |
| | | | | Plug-In Integration | | | |
| | | Feature 4 | 3 | Customization | 2 | 6 | |
| | | | | Required | | | |
| | | Feature 5 | 3 | Customization | 3 | 9 | |
| | | | | Required | | | |

### Assessment of the Plurality of OSS Products to Identify an Optimum OSS Product

Once the ideal scorecard, the benchmark scorecard, and the product scorecards are generated, the assessing module 126 may be configured to compare the product score of each of the product categories of each of the OSS products with the benchmark score of each category. If any of the OSS product is equal to or surpasses the benchmark score of all product categories individually, then that OSS product is considered as an optimum OSS product. In a scenario where two OSS products have product scores greater than the benchmark scores, then that OSS product is identified as an optimum OSS product which has total product score equal to or close to the total ideal score. In another scenario where two OSS products have equal product scores and the product scores are greater than the benchmark scores, then that OSS product is identified as an optimum OSS product which has lower commercial cost.

FIGS. 2b and 2c illustrate exemplary radar chart representation 210 and a bar chart representation 220 depicting comparison of total scores attained by product 1, product 2, and product 1 with a benchmark score. As shown in FIG. 2b, the benchmark score and the product score of the product categories ‘About Product’, ‘Product Strategy’, ‘Product Offerings’, ‘Product Architecture’, ‘Product Support’, and ‘Commercials’ for each of the product 1, 2, and 3 are depicted in the radar chart representation 210. Similarly, in FIG. 2c, the benchmark score and the product score of the product categories ‘About Product’, ‘Product Strategy’, ‘Product Offerings’, ‘Product Architecture’, ‘Product Support’, and ‘Commercials’ for each of the product 1, 2, and 3 are depicted in the bar chart representation 220.

According to an example, the product score of each of the product categories of the product 1, 2, and 3 is depicted in Table 11 (provided below). The benchmark score of each product category is also depicted in the table.

TABLE 11

| | | | | Benchmark |
|---|---|---|---|---|
| Product Category | Product 1 | Product 2 | Product 3 | score |
| About Product | 36 | 37 | 30 | 33 |
| Product Strategy | 18 | 14 | 4 | 17 |
| Product Offerings | 21 | 16 | 24 | 16 |
| Product Architecture | 38 | 46 | 29 | 38 |
| Product Support | 23 | 27 | 12 | 16 |
| Total Score | 156 | 160 | 99 | 135 |

As shown in the Table 11 above, the benchmark score for the product categories ‘About Product’, ‘Product Strategy’, ‘Product Offerings’, ‘Product Architecture’, ‘Product Support’, and ‘Commercials’ are 33, 17, 16, 38, and 16, respectively. Since, the OSS product should score equal to or more than the benchmark score in each product category so as to be eligible for selection as an optimum OSS product, a minimum score of 33 has to be arrived for all product criterions of the product category ‘About Product’ put together. Similarly a minimum score of 17 is required for product category ‘Product Strategy’ for the product to be considered for adoption.

As depicted in the above table, for the product category ‘Product Strategy’, a product score of 14 is achieved by product 2 and a product score of 4 by product 3 and both the product scores of product 2 and product 3 are less than the benchmark score of 17. Therefore product 2 and 3 are thereby not considered for adoption, irrespective of product 2 deriving a total score of 160 for all the product categories put together which is greater than the total benchmark score of 135. It can also be seen from the above table that the product 1 surpasses the benchmark score of all product categories individually and for all the product categories put together. Thus, amongst the three exemplary products, product 1 would be considered as an optimum OSS product for adoption, irrespective of product 1 deriving a total product score of 156 which is less than the total product score of 160 derived for product 2.

Therefore, based on such an exhaustive collection of product categories and product criterions which are easily embeddable codes, and scoring mechanism, an optimum OSS product is reliably and accurately identified for adoption based on requirement of the user.

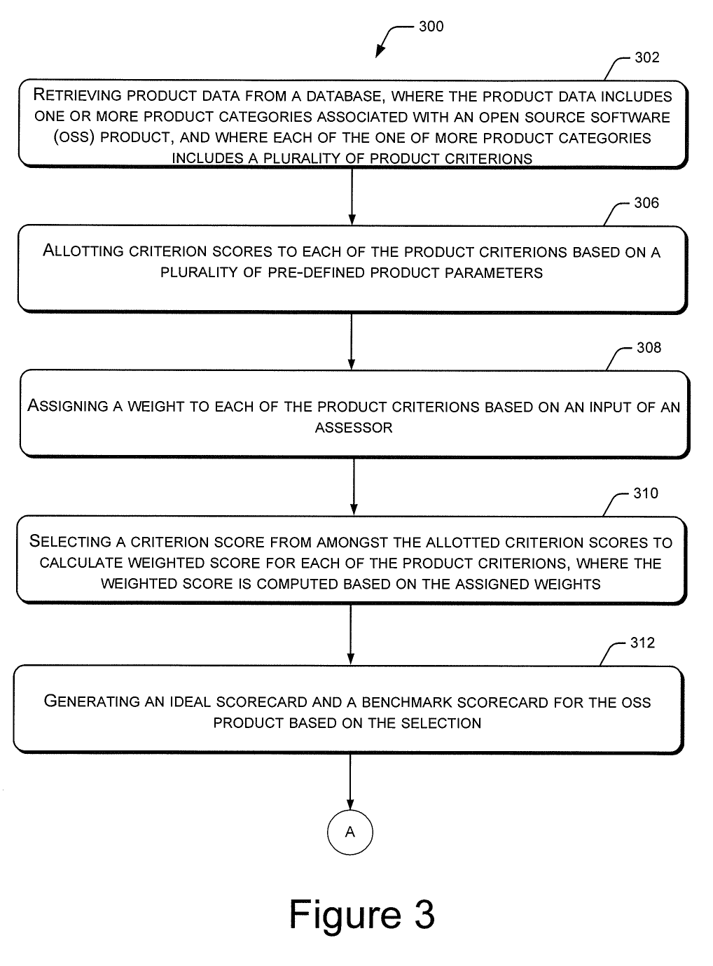

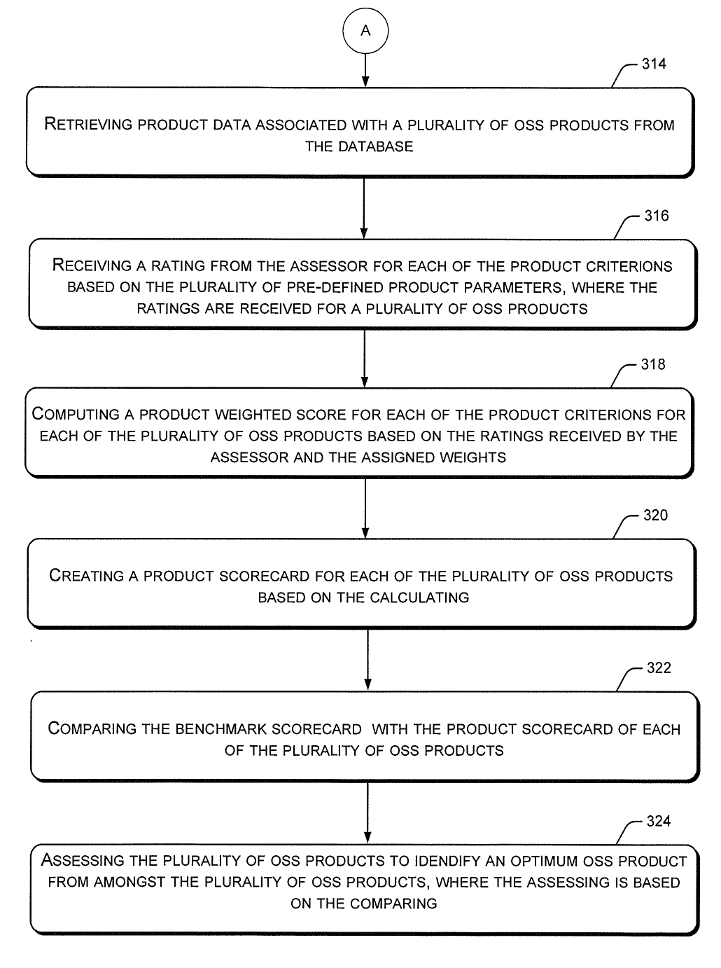

FIG. 3 illustrates a computer-implemented method for assessment of a plurality of Open Source Software (OSS) products to identify an optimum OSS product, in accordance with the embodiment of the present subject matter.

The method 300 may be described in the general context of computer executable instructions. Generally, computer executable instructions can include routines, programs, objects, components, data structures, procedures, modules, functions, etc., that perform particular functions or implement particular abstract data types. The methods 300 may also be practiced in a distributed computing environment where functions are performed by remote processing devices that are linked through a communications network. In a distributed computing environment, computer executable instructions may be located in both local and remote computer storage media, including memory storage devices.

The order in which the methods 300 are described is not intended to be construed as a limitation, and any number of the described method blocks can be combined in any order to implement the methods 300, or alternative methods. Additionally, individual blocks may be deleted from the methods without departing from the spirit and scope of the subject matter described herein. Furthermore, the methods 300 can be implemented in any suitable hardware, software, firmware, or combination thereof.

Referring to FIG. 3, at block 302, the method 300 includes retrieving product data 130 from a database. The product data 130 includes one or more pre-defined product categories associated with an Open Source Software (OSS) product, interchangeably referred to as product. The one or more product categories referred herein may include, but not limited to, a ‘About Product’ category, a ‘Product Strategy’ category, a ‘Product Offerings’ category, a ‘Product Architecture’ category, a ‘Product Support’ category, and a ‘Commercials’ category. Each of the product categories may have a plurality of product criterions associated therewith. In one implementation, the scoring module 118 of the assessment system 102 retrieves the product data 130.

At block 304, the method 300 includes allotting criterion scores to each of the product criterions based on a plurality of pre-defined product parameters. In an example, the criterion scores may be allotted to the product criterion ‘Launch Year’ based on assessing a product parameter, such as the year when the OSS Product was first released in the market. In the said example, if the OSS product is in the market for more than 5 years, then a criterion score of 3 is allotted to the product criterion ‘Launch Year’ and if the OSS product is in market for more than 2 years but less than 5 years, then a criterion score of 2 is allotted. In one implementation, the scoring module 118 of the assessment system 102 allots criterion scores to each of the product criterions associated with the one or more product categories.

At block 308, the method 300 includes assigning a weight to each of the product criterions based on assessor input. The weights may be assigned based on relevance of each of the product criterions on each of the product categories. In an example, if for an assessor, the product criterion ‘Product Technology’ is most relevant with respect to product category ‘About Product’, then the assessor may provide a weight of 5 to the product criterion ‘Product Technology’. In one implementation, the assigning module 120 assigns weight to each of the product criterions of based on assessor input.

At block 310, the method 300 includes selecting a criterion score from amongst the allotted criterion scores to calculate a weighted score for each of the product criterions. The weighted score for each of the product criterions is calculated based on multiplying the selected criterion score and the assigned weight. In an implementation, the generation module 124 is configured to select a criterion score from amongst the allotted criterion scores to calculate a weighted score for each of the product criterions.

At block 312, the method 300 includes generating an ideal scorecard and a benchmark scorecard for the OSS product based on the selection of the criterion scores. The ideal scorecard may be indicative of a total ideal score, i.e., cumulative sum of ideal scores of all the product categories and the benchmark scorecard may be indicative of a total benchmark score, i.e., cumulative sum of benchmark scores of all the product categories. In one implementation, the generation module 124 is configured to generate the ideal and the benchmark scorecards for the OSS product.

At block 314, the method 300 includes retrieving product data 130 associated with a plurality of OSS products from the database. The product data 130 includes one or more pre-defined product categories associated with the plurality of OSS products. The one or more product categories referred herein may include, but not limited to, a ‘About Product’ category, a ‘Product Strategy’ category, a ‘Product Offerings’ category, a ‘Product Architecture’ category, a ‘Product Support’ category, and a ‘Commercials’ category. Further, each of the product categories includes a plurality of product criterions. In one implementation, the computation module 124 retrieves the product data 130 associated with the plurality of OSS products.

At block 316, the method 300 includes receiving a rating from the assessor for each of the product criterions of each of the plurality of OSS products. The ratings may be received based on the plurality of pre-defined product parameters. In an example, ratings for three OSS products, namely product 1, product 2, and product 3 may be received from the assessor. Taking an example of product 1 which is in market for more than 5 years, for the product criterion ‘Launch Year’, the rating of 3 may be received based on the product parameter, that is, product is in market for more than 5 years. In another example, if the product 2 is in market for less than 2 years, then rating of 1 is received for the product criterion ‘Launch Year’. In one implementation, the computation module 124 receives ratings from the assessor for the OSS products.

At block 318, the method 300 includes computing a product weighted score for each of the product criterions for each of the plurality of OSS products based on the ratings received by the assessor and the assigned weights. To compute the product weighted score for each of the product criterions, the received rating is multiplied with the weight of the product criterion. For example, if the rating of 3 is received and the weight is 2, then the product weighted score of 6 (3×2) is computed. In one implementation, the computation module 124 is configured to compute the product weighted score for each of the product criterions.

At block 320, the method 300 includes creating a product scorecard for each of the plurality of OSS products. The product scorecard for an OSS product may be indicative of a total product score, i.e., cumulative sum of product scores of all the product categories. The product score for each product category is calculated based on the computed product weighted score. Further, product weighted scores of each of the product criterions of each the product categories is added to get a product score for each product category. In one implementation, the computation module 124 is configured to create the product scorecard for each of the plurality of OSS products.

At block 322, the method 300 includes comparing the benchmark scorecard with the product scorecard of each of the plurality of OSS products. In one implementation, the assessing module 126 is configured to compare the benchmark scorecard with the product scorecard of each of the OSS products.

At block 324, the method 300 includes assessing the plurality of OSS products to identify an optimum OSS product from amongst the plurality of OSS products based on the comparing. For example, when the benchmark scorecard is compared the plurality of OSS products, if any of the OSS product is equal to or surpasses the benchmark score of all product categories individually, then that OSS product is considered as an optimum OSS product. In a scenario where two OSS products have product scores greater than the benchmark scores, then that OSS product is identified as an optimum OSS product which has total product score equal to or close to the total ideal score. In one implementation, the assessing module 126 is configured to assess the plurality of OSS products to identify an optimum OSS product from amongst the plurality of OSS products.

Although embodiments for methods and systems for assessment of the OSS products have been described in a language specific to structural features and/or methods, it is to be understood that the invention is not necessarily limited to the specific features or methods described. Rather, the specific features and methods are disclosed as exemplary embodiments for assessment of the OSS products.

I/We claim:

1. A computer-implemented method for assessment of a plurality of Open Source Software (OSS) products, the method comprising:
receiving, from an assessor, a rating for each of a plurality of product criterions associated with one or more product categories of each of the plurality of OSS products, wherein the rating is based on product parameters of the plurality of OSS products;
computing, by an assessment system, a product weighted score for each of the product criterions based at least on the rating;
generating, by the assessment system, a product scorecard for each of the plurality of OSS products based on the product weighted score, wherein the product scorecard is indicative of a total product score obtained by a cumulative sum of product scores of the one or more product categories; and
assessing, by the assessment system, the plurality of OSS products, based on a comparison of the product scorecard of each of the plurality of OSS products with a benchmark scorecard, to identify an optimum OSS product for the assessor.

2. The method as claimed in claim 1, wherein the computing is further based on a weight associated with each of the product criterions.

3. The method as claimed in claim 2, wherein the product weighted score is computed based on multiplication of the rating and the weight associated with each of the product criterions.

4. The method as claimed in claim 1 further comprising:
retrieving product data of the plurality of OSS products from a database, wherein the product data comprises the plurality of product criterions associated with the one or more product categories;
allotting a plurality of criterion scores to each of the product criterions of an OSS product based on the product parameters;
selecting a criterion score from amongst the plurality of criterion scores to calculate a weighted score for each of the product criterions; wherein the weighted score is calculated based on multiplication of the criterion score and the weight assigned to each of the product criterions; and
generating an ideal scorecard and the benchmark scorecard for the OSS product based on the selection.

5. The method as claimed in claim 1, wherein the product categories include a About Product category, a Product Strategy category, a Product Offerings category, a Product Architecture category, a Product Support category, and a Commercials category.

6. The method as claimed in claim 1, wherein the benchmark scorecard comprises a total benchmark score obtained by a cumulative sum of benchmark scores of the one or more product categories.

7. The method as claimed in claim 4, wherein the ideal scorecard comprises a total ideal score obtained by a cumulative sum of ideal scores of the one or more product categories.

8. An assessment system for assessment of a plurality of Open Source Software (OSS) products comprising:
a processor;
a computation module coupled to the processor, the computation module configured to:
receive a rating, for each of a plurality of product criterions of each of the plurality of OSS, from an assessor based on product parameters of the plurality of OSS products, wherein the plurality of product criterions are associated with one or more product categories;
compute a product weighted score for each of the plurality of the product criterions based on the rating and a weight assigned to each of the product criterions;
generate a product scorecard for each of the plurality of OSS products based on the product weighted score; and
an assessing module coupled to the processor, the assessing module configured to:
identify an optimum OSS product from amongst the plurality of OSS products based on the assessment of the product scorecard and a benchmark scorecard of an OSS product.

9. The assessment system as claimed in claim 8, wherein the assessing module is further configured to compare the product scorecard of each of the plurality of OSS products with the benchmark scorecard to identify the optimum OSS product.

10. The assessment system as claimed in claim 8 further comprising a scoring module configured to:
retrieve product data of the plurality of OSS products from a database, wherein the product data comprises the plurality of product criterions associated with the one or more product categories; and
allot a plurality of criterion scores to each of the product criterions of the OSS product based on the product parameters.

11. The assessment system as claimed in claim 8 further comprising an assigning module configured to assign weight to each of the product criterions of the OSS product based on an input from the assessor.

12. The assessment system as claimed in claim 11, wherein the product weighted score is computed based on multiplication of the rating and the weight associated with each of the product criterions.

13. The assessment system as claimed in claim 8 further comprising a generation module configured to select a criterion score from amongst the plurality of criterion scores to calculate a weighted score for each of the product criterions of the OSS product and generate an ideal scorecard and the benchmark scorecard for the OSS product based on the selection.

14. The assessment system as claimed in claim 13, wherein the weighted score is calculated based on multiplication of the criterion score and a weight associated with each of the product criterions.

15. The assessment system as claimed in claim 8, wherein the product categories include a About Product category, a Product Strategy category, a Product Offerings category, a Product Architecture category, a Product Support category, and a Commercials category.

16. The assessment system as claimed in claim 8, wherein the benchmark scorecard comprises a total benchmark score, and wherein the total benchmark score is cumulative sum of benchmark scores of the one or more product categories.

17. The assessment system as claimed in claim 8, wherein the product scorecard for each of the plurality of OSS products comprises a total product score, and wherein the total product score is cumulative sum of product scores of the one or more product categories.

18. The assessment system as claimed in claim 13, wherein the ideal scorecard comprises a total ideal score, and wherein the total ideal score is cumulative sum of ideal scores of the one or more product categories.

19. A non-transitory computer-readable medium having embodied thereon a computer program for executing a method comprising:
receiving, from an assessor, a rating for each of a plurality of product criterions associated with one or more product categories of each of the plurality of OSS products, wherein the rating is based on product parameters of the plurality of OSS products;
computing, by an assessment system, a product weighted score for each of the product criterions based at least on the rating;
generating, by the assessment system, a product scorecard for each of the plurality of OSS products based on the product weighted score, wherein the product scorecard is indicative of a total product score obtained by a cumulative sum of product scores of the one or more product categories; and
assessing, by the assessment system, the plurality of OSS products, based on comparison of the product scorecard of each of the plurality of OSS products with a benchmark scorecard, to identify an optimum OSS product for the assessor.

20. The non-transitory computer-readable medium as claimed in claim 19, wherein the method further comprising:
retrieving product data of the plurality of OSS products from a database, wherein the product data comprises the plurality of product criterions associated with the one or more product categories;
allotting a plurality of criterion scores to each of the product criterions of an OSS product based on the product parameters;
selecting a criterion score from amongst the plurality of criterion scores to calculate the weighted score for each of the product criterions; wherein the weighted score is calculated based on multiplication of the criterion score and the weight assigned to each of the product criterions; and
generating an ideal scorecard and the benchmark scorecard for the OSS product based on the selection.
